(19) United States
(12) Patent Application Publication
(10) Pub. No.: US 2019/0334740 A1
(43) Pub. Date: Oct. 31, 2019

(54) ENERGY HARVESTING FROM FIRE PANEL

(71) Applicants: Mohammad Mohiuddin, Boynton Beach, FL (US); Melwyn F. Sequeira, Plantation, FL (US); Mark Antilla, Davie, FL (US); Hubert A. Patterson, Boca Raton, FL (US)

(72) Inventors: Mohammad Mohiuddin, Boynton Beach, FL (US); Melwyn F. Sequeira, Plantation, FL (US); Mark Antilla, Davie, FL (US); Hubert A. Patterson, Boca Raton, FL (US)

(73) Assignee: Johnson Controls Fire Protection LP, Boca Raton, FL (US)

(21) Appl. No.: 16/309,609

(22) PCT Filed: Jun. 15, 2016
(86) PCT No.: PCT/US16/37494

§ 371 Date: Dec. 13, 2018

(51) Int. Cl. H04L 12/40; G08B 25/04; G08B 26/00

(52) U.S. Cl. CPC H04L 12/40045; G08B 26/001; G08B 25/045

(57) ABSTRACT

In a fire alert system energy is harvested from a wire line pair (408) used to provide primary electrical power from a fire panel central monitoring station to a plurality of remote devices (406). The fire panel central monitoring station begins communications with a remote device by modulating the voltage on the wire line pair so as to communicate a first message (502) to one of the plurality of remote devices. Thereafter, one of the remote devices will respond to the first message with a second message (504) by modulating the voltage on the line pair. Energy is selectively harvested from the wire line pair at one or more of the remote devices in accordance with the remote device address specified in the first message.

### BACKGROUND OF THE INVENTION

### Statement of the Technical Field

The inventive arrangements relate to fire alert systems and more particularly to methods and systems for extracting additional energy from legacy fire panels to power auxiliary devices.

### Description of the Related Art

Buildings have fire alert systems to facilitate alerting of authorities in the event of a fire. To facilitate such alerting, such systems generally include a central monitoring panel called a fire panel, and various initiating devices which are distributed around a building to detect the presence of a fire or otherwise generate a fire alert. For example, smoke and heat detectors can sense the occurrence of a fire and cause an alert to be initiated. Also, pull stations can be provided to allow persons to manually initiate a fire alert by activating a lever or switch indicator installed in them. A pair of wires (line pair) is used to connect each device in series with another of the same type. For example, smoke/heat detectors are commonly connected in a daisy-chain manner via the pair of wires to the fire panel. The two wires provided are used for both communication and to provide power to each detector.

During normal operations, the fire panel and its connected devices are consistently powered. The fire panel receives primary electrical power from a utility power line connection and usually has a backup battery for the case where there is an interruption in the utility power. The fire panel provides a DC power supply voltage as an output on the line pair to power each of the detector devices. Each device consumes a minute amount of power continuously such that the total energy drawn by all the devices on a line pair does not exceed the limit of the available power from the fire panel. The same line pair that is bringing power to the devices is also used for communication. Polling is initiated from the fire panel (being the master of setup) to get the status of each device connected on the wire. Each device is programmed with a unique hexadecimal identifier. During normal operation, fire-panel polls or interrogates each device by communicating electrical signals over the wire line pair used to connect them to the fire panel. The electrical signals specify which device is being polled by indicating the device's unique identifier. The device replies to the poll or interrogation signal with its status including a detection condition (e.g. smoke is detected/smoke is not detected) back to the fire panel.

Smoke and heat detectors used in conventional fire detection systems have the potential to be enhanced by incorporating additional electronic circuits and components therein. But the addition of more capability usually involves greater power consumption by each detector. So the power requirements of a chain of detectors with enhanced capability could potentially exceed the available power which can be provided from the fire panel. This fact limits the possibility of enhancing fire detection systems to include detectors having greater capability.

### SUMMARY OF THE INVENTION

Embodiments of the invention concern a method for harvesting available electrical power in a fire alert system. In a fire alert system a wire line pair is used to provide primary direct current (DC) electrical power from a fire panel central monitoring station to a plurality of remote devices. Bidirectional communications are performed between the fire panel central monitoring station and the plurality of remote devices by selectively modulating a voltage of the DC electrical power on the wire line pair in accordance with a predetermined communication protocol. The bidirectional communications are initiated by using the fire panel central monitoring station to modulate the voltage on the wire line pair so as to communicate a first message to one of the plurality of remote devices. Most commonly, this will be an interrogation or polling signal used to query a remote device concerning a fire detection status. Thereafter, one of the remote devices will respond to the first message with a second message by modulating the voltage on the line pair. The device that responds will usually be the remote device which is indicated by an address specified in the first message. The method further involves selectively harvesting energy from the wire line pair at one or more of the remote devices in accordance with the remote device address specified in the first message.

According to one aspect, the harvesting of energy is performed at the remote device having the address specified in the first message. Further, the harvesting of energy can be performed at a time which is concurrent with modulating the voltage on the line pair to form the second message. In some scenarios, the harvesting of energy can also be performed during at least one guard period which is defined as occurring immediately before or after the second message. The energy which is harvested as a result of the energy harvesting operations is stored in at least one energy storage element such as a rechargeable battery and/or a capacitor.

Embodiments described herein also include an electronic device for remote wire line connection to a fire panel central monitoring station in a fire alert system. The electronic device can include a voltage regulator configured to regulate a supply voltage used to power the electronic device. More particularly, the voltage regulator is configured to receive through a wire line pair primary direct current (DC) electrical power to facilitate powering the electronic device. A receiver circuit and a transmitter circuit are also provided. These circuits are configured to facilitate bidirectional communications between the electronic device and a remote fire panel central monitoring station of the fire alert system. Such bidirectional communications are in accordance with a predetermined communication protocol which involves selectively modulating a voltage of the DC electrical power on the wire line pair. The electronic device also includes at least one energy harvesting circuit configured to selectively harvest electrical power from the wire line pair at certain times.

At least one control circuit is also provided as part of the electronic circuit. The at least one control circuit is configured to determine an initiation of the bidirectional communications by the fire panel central monitoring station. For example, such determination may result from a modulation of the voltage on the wire line pair by the fire panel and detected by the receiver circuit. The modulation in such a scenario will comprise a first message to the electronic device. The at least one control circuit will cause the transmitter circuit to respond to the first message with a second message by modulating the voltage on the line pair. For example, the second message may be generated when a predetermined device address is specified in the first message. The at least one control circuit is further configured to selectively cause the energy harvesting circuit to harvest energy from the wire line pair in accordance with the device address specified in the first message.

### BRIEF DESCRIPTION OF THE DRAWINGS

Embodiments will be described with reference to the following drawing figures, in which like numerals represent like items throughout the figures, and in which:

FIGS. 1A and 1B are schematic diagrams that are useful for understanding a first and second manner in which a fire alarm control panel is connected to a plurality of detector devices.

FIG. 2 is a plot of a first waveform that is useful for understanding how a signaling protocol used in a fire alarm control panel can be used for energy harvesting.

FIG. 3 is a plot of a second waveform that is useful for understanding how an alternative signaling protocol used in a fire alarm control panel can be used for energy harvesting.

FIG. 4 is a block diagram that is useful for understanding how an exemplary device in a fire alert system can harvest energy during a signaling period.

FIG. 5 is a timing diagram that is useful understanding when energy harvesting operations can be performed in accordance with a first embodiment.

FIG. 6 is a timing diagram that is useful for understanding when energy harvesting operations can be performed in accordance with a second embodiment.

FIG. 7 is a more detailed block diagram showing additional components of the detection device in FIG. 4.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

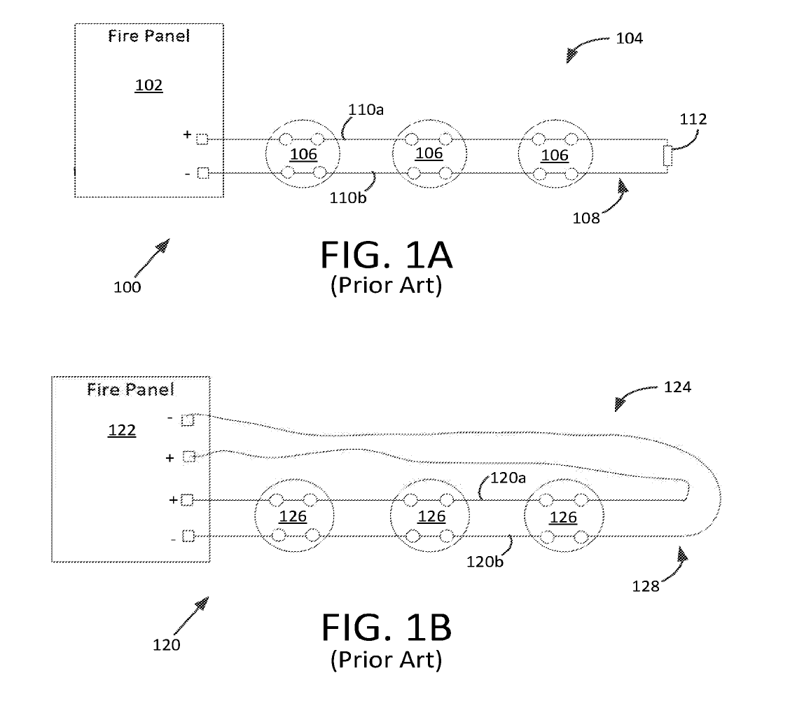

A fire alert system provided in a building will include a central monitoring panel called a fire panel, and various initiating devices which are distributed around a building to detect the presence of a fire or otherwise generate a fire alert. An initiating device can include a detector device (such as a smoke or heat detector) or pull station which allows a user to manually trigger an alert by pulling a lever. In a fire alert system 100 shown in FIG. 1A, a fire panel 102 is connected to one or more signaling line circuits (SLCs) 104. Only a single signaling circuit is shown in FIG. 1, but it should be understood that systems for larger facilities may utilize multiple SLCs.

Each SLC 104 is comprised of a plurality of detector devices (e.g. smoke and/or heat detectors) 106 which utilize various types of sensors to detect the occurrence of a fire. The detector devices cause an alert to be initiated at the fire panel in the event that a fire is detected. The connection between the fire panel and the detector devices 106 is provided by a line pair 108. The line pair is comprised of a pair of electrically conductive wires 110a, 110b which are used to connect each detector device 106 with another device, which could be of the same or different type depending upon the particular system. A terminating resistor 112 can be provided at a terminal end of the SLC which is remote from the fire panel.

In some fire alert systems, a line pair is connected at both ends to the fire panel to form a loop circuit as shown in FIG. 1B. In such a scenario, a fire panel 122 is connected to detector devices 126 by conductive wires 120a, 120b which form a line pair 128. The loop circuit arrangement of SLC 124 is intended to reduce the number of detection devices 126 that are disconnected from the fire panel 122 in the event of a break somewhere along the length of the conductive wires 120a, 120b. Regardless of whether the SLC is arranged as shown in FIG. 1A or 1B, the line pair is used to provide DC power to each detector device and to facilitate data communications between the fire panel and each of the plurality of detector devices. In FIGS. 1A and 1B, the fire panel 102, 122 can be similarly connected to additional circuits (not shown) to provide power and signaling to multiple notification devices (not shown) such as annunciators or strobes to alert building occupants in case of fire.

An embodiment fire panel 102, 122 can be an addressable fire alarm control panel which utilizes a signaling protocol to monitor and control numerous detector devices 106, 126 which may be connected in an SLC 104, 124. In a system utilizing an addressable fire panel, each detector device 106, 126 has its own address (e.g. a hexadecimal address) and the fire panel can selectively determine the state of each device connected by utilizing a communication protocol to selectively communicate with each device. Some signaling protocols permit initiating devices and notification devices to be connected to the same SLC. Accordingly, an SLC 104, 124 in an embodiment fire alert system 100, 120 can in some scenarios include initiating devices and notification devices on the same circuit without limitation.

In FIGS. 1A and 1B, the detector devices 106, 126 are powered by a DC voltage provided by the line pair 108, 128 from the fire panel 102, 122. For example, the fire panel may provide a DC output voltage of between 24 to 38 volts DC. The invention is not limited in this regard and other DC output voltages can also be used for this purpose. Each detector device draws relatively little current to operate and therefore consumes minimal power. Still, the total electrical load associated with the plurality of detector devices will be a function of the number of devices that are connected along the SLC. Accordingly, the total number of detection devices which are connected to a particular line pair must be constrained so as to avoid drawing excessive current from the fire panel.

In FIGS. 1A and 1B, communication is initiated with each detection device from the fire panel 102, 122. For example, the communication can be initiated to obtain status and/or fire alert sensing information from each detector device 106, 126 connected across the line pair 108, 128. Each detector device 106, 126 is programmed with a unique address, such as a hexadecimal value, which is assigned to that device. During normal operation, the fire-panel 102, 122 polls or interrogates each detector device 106, 126 by communicating electrical signals over the line pair 108, 208.

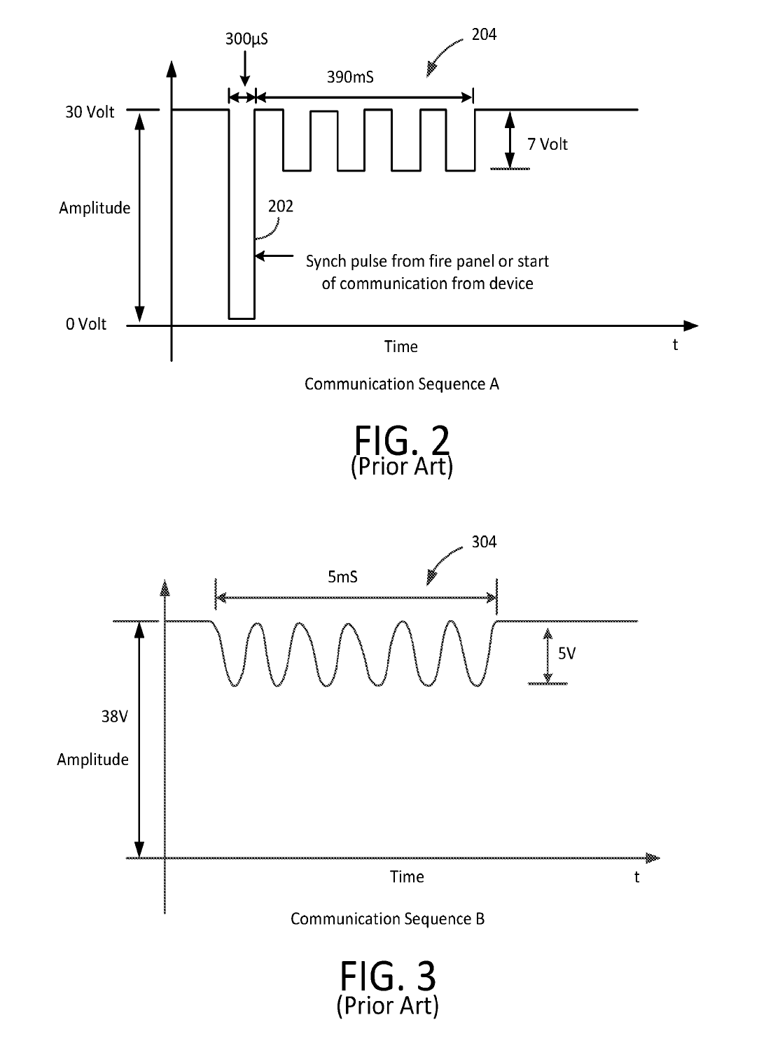

According to one aspect, the electrical signals used to communicate between the fire panel 102, 122 and the detector devices 106, 126 can comprise a modulation of the DC voltage that is also used to power the detector devices. For example, the modulation can comprise a series of pulses that are used to communicate information in accordance with a predetermined coding scheme defined by a communication protocol. Such an arrangement is illustrated in FIG. 2 which shows a communication sequence A wherein a 30 volt DC level is modulated by a series of pulses. In the example shown in FIG. 2 the amplitude modulation can include a synchronizing pulse 202 followed by signaling data pulses or modulation 204. The same or a similar communication protocol as shown in FIG. 2 can also be used when communicating from the detector devices 106, 206 to the fire panel 102, 122. In some embodiments, the synch pulse 202 can be omitted in the communications to and/or from the fire panel. FIG. 3 shows a communication sequence B in which the amplitude of a 38 volt DC level is modulated by a fire panel to communicate a data signal 304 in accordance with a different communication protocol. Communication protocol B similarly involves amplitude modulating a DC power supply voltage. The same or a similar signaling protocol shown in FIG. 3 can also be used for a detector device 106, 206 to communicate with the fire panel 102, 122.

Conventional fire alert systems arranged as described herein with respect to FIGS. 1A and 1B are known in the art and therefore will not be described here in detail. Likewise, various fire panel communication protocols used for signaling as described herein with respect to FIGS. 2 and 3 are known and therefore will not be described in detail. However, there is a growing interest in providing upgraded detector devices in fire alert systems. For example, such detector devices could potentially include functions, features and sensors which exceed those which are currently available in convention detector devices used in fire alert systems. Further, it would be desirable to retrofit such upgraded detector devices into existing fire alert systems. But the inclusion of additional functions, features and sensors in the detector devices usually involves an increase in the power consumed by the device. This is a problem because installed fire panels would in many instances not be capable of providing sufficient power to an SLC if existing detector devices were replaced with upgraded units consuming significantly more power. Methods and systems are therefore disclosed herein to facilitate powering such upgraded devices connected to an SLC without the need to retrofit existing fire panels or associated wiring in a facility. These same methods and systems facilitate improved capabilities in detector devices at new fire alert system installations while limiting power supply demands that are placed on the fire panel.

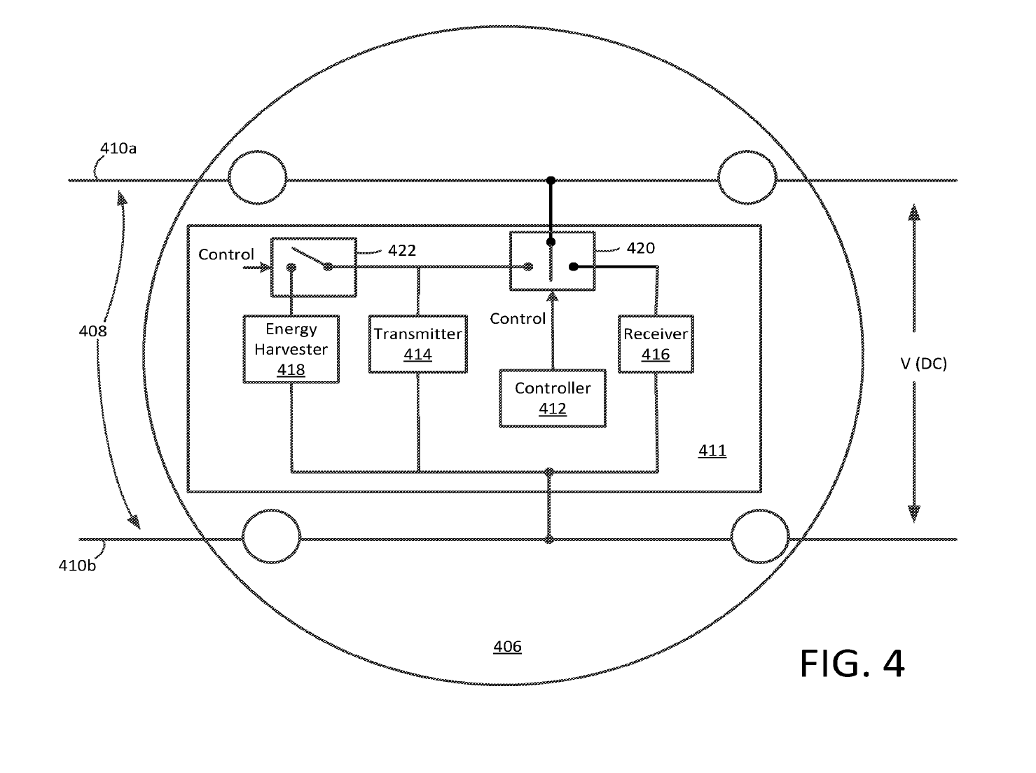

A block diagram showing certain elements of an exemplary detector device 406 is illustrated in FIG. 4. The detector device 406 is connected across wires 410a, 410b comprising line pair 408 of an SLC. A DC supply voltage is applied across the line pair 408 by a fire panel (not shown in FIG. 4). The detector device 406 includes an electronic circuit 411 comprised of a controller 412, a transmitter 414, a receiver 416 and a switching element 420. The receiver 416 is configured to facilitate detection of signals communicated by the fire panel in accordance with a signaling protocol as described herein. Accordingly, the receiver 416 can detect modulated data signals communicated over the line pair 408. For example, the receiver can detect interrogation or polling signals comprising requests from the fire panel to report on the status or other conditions at the device. These signals can be decoded by the receiver and/or by a controller 412 in communication with the receiver 416.

The transmitter 414 is configured to transmit data to a fire panel (e.g., in response polling or interrogation signals which are directed to the particular detector device 406). This data can be transmitted by the transmitter 414 using a signaling protocol as described herein. The controller 412 can determine which of the transmitter 414 or receiver 416 is active and/or operatively connected to line pair 408. For example, this function can be facilitated by the switching element 420 which selectively controls whether the transmitter 414 or receiver 416 is operatively connected to the line pair. Most of the time when a fire alert system is operational, the receiver 416 will be operatively connected to the line pair 408 to facilitate monitoring of communications from the fire panel. This will usually change when the fire panel initiates an interrogation or polling signal addressed to the particular detector device 406. When this happens, the receiver 416 can be disconnected or otherwise made inactive and the transmitter 414 is made active and/or operatively connected to the line pair to facilitate transmit operations.

An embodiment detector device 406 can also include an energy harvester 418. The energy harvester 418 can be arranged so that a voltage supplied by the line pair 408 is applied to the energy harvester under certain conditions. For example, one or more switch elements 420 and 422 can be used to facilitate such connection. The switch elements 420 and 422 can be under the operative control of controller 412 to coordinate operations of the detector device 406 in a manner described herein. In the embodiment shown in FIG. 4, the energy harvester is disposed in a parallel circuit arrangement with respect to the transmitter 414. However, it should be appreciated that the invention is not limited in this regard and in some scenarios the energy harvester 418 could alternatively be disposed in series with the transmitter for purposes of harvesting energy. As a further alternative, two or more energy harvesting circuits 418 could be provided with one energy harvester in parallel with transmitter 414 and one in series with transmitter 414.

A detector device 406 with upgraded or enhanced capability will usually consume more power as compared to a conventional detector device. Therefore, if a plurality of enhanced detector devices 406 in an SLC were permitted to all simultaneously draw the additional current they need for operating, the total power consumption on a particular line pair 408 could easily exceed the power supply limitations of a connected fire panel supplying such power. But a single detector device 406 can potentially draw a relatively small amount of additional current from the fire panel for a period of time without causing any negative effects to the fire alert system. Accordingly, an energy harvester 418 of a detector device 406 can be selectively controlled to harvest additional power only during certain controlled time periods. These time periods can be selected so that they are exclusive to the particular detector device so as to ensure that energy harvesters 418 in other detector devices are not attempting to also harvest additional energy during such time period. According to one aspect, the controlled time period for energy harvesting can be coordinated based on a timing associated with an interrogation signal.

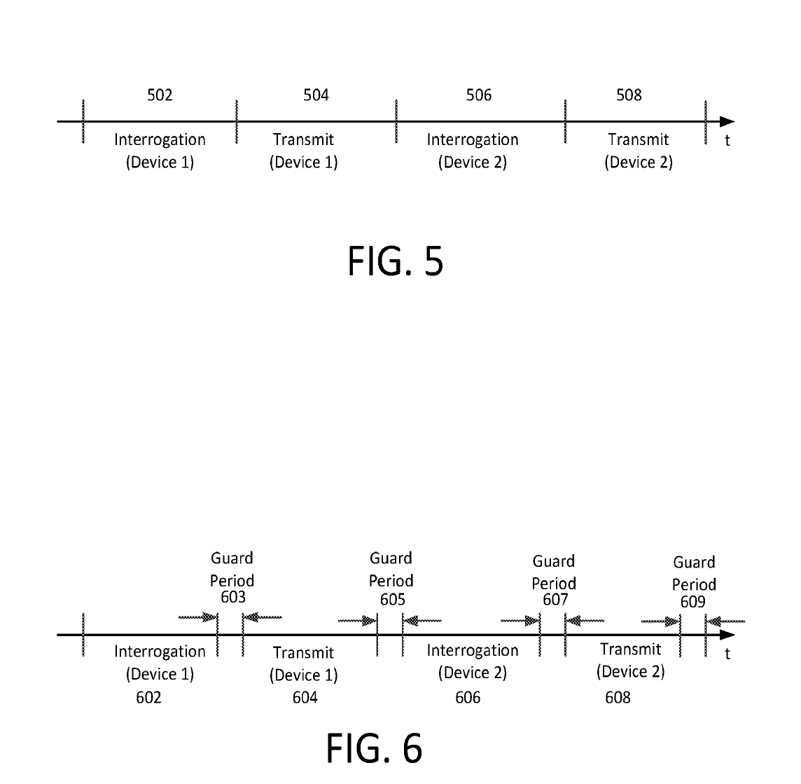

For example, one method for ensuring that an energy harvester 418 only harvests electric power on a line pair 408 during a time period exclusive to a particular detector device 406 involves selectively limiting such energy harvesting to periods during which the particular detector device 406 is transmitting. As explained herein with respect to FIGS. 1 and 2, the fire panel already coordinates communication access to the line pair by polling or interrogating detector devices using their unique address to initiate reporting status from each detector device. This control mechanism can be used advantageously to coordinate energy harvesting among the detector devices. In one scenario, a particular detector device 406 can be configured to perform energy harvesting only during transmit operations involving that device and/or during only a portion of such transmit operations. This concept is illustrated in FIG. 5, which shows that a fire panel communicates an interrogation signal to a first detection device (Device 1) during an interrogation period 502, thereby causing the first detection device to transmit a reply during a transmit period 504. Device 1 performs energy harvesting during all or part of transmit period 504. Thereafter, the fire panel communicates an interrogation signal directed to a second detection device (Device 2) during a subsequent interrogation period 506, thereby causing the second detection device to transmit a reply during a transmit period 508. Device 2 performs energy harvesting during transmit period 508. The process can continue for each of a plurality of n detector devices which are connected to an SLC.

In an alternative embodiment, detector devices can be configured to also perform energy harvesting during a time period associated with an interrogation signal. For example, after a Device 1 performs energy harvesting during transmit period 504 as described, the device may also perform energy harvesting during an interrogation period 506 (addressed to a different device) which immediately follows. Since Device 1 was the last device to be addressed by the fire panel, and no other detector device would be harvesting energy during interrogation period 506, it would be possible for Device 1 to take advantage of the additional time associated with following interrogation period 506 to harvest some additional energy. Other detector devices connected to the SLC could similarly harvest energy during a time period immediately following a transmit time period for the particular device. Of course, it is not necessary that the additional energy harvesting occur during an interrogation time period immediately following a transmit time period for that particular device. In some scenarios, each detector device could have an offset value i so that it would perform such additional energy harvesting during an ith interrogation time period which follows a transmit time for such device.

With reference to FIGS. 2 and 3 it can be observed that a detector device (e.g. detector device 406) will cause a DC voltage supplied across a line pair by a fire panel to vary during a detector device transmit period in accordance with a predetermined signaling protocol. As shown in FIGS. 2 and 3, a voltage potential exists across the line pair during transmit times. For example, a modulated DC voltage exits across the line pair during a time period associated with a modulation 204, 304. In the example shown in FIG. 2, this voltage potential varies between 30 volts and 23 volts. In the example shown in FIG. 3, the voltage potential varies between 38 volts and 33 volts. An energy harvester 418 connected across the line pair during a period when modulation 204, 304 is present can draw a limited amount of current or power to facilitate energy harvesting functions described herein.

In some scenarios, the current drawn by the harvester during this time period can cause the DC voltage on the line pair to droop somewhat. But the energy harvester 418 can be designed so that the voltage droop is sufficiently small so as not to adversely affect communications and/or cause an adverse response from the fire panel. The amount of voltage droop which can be accommodated or permitted in each system will depend on the system specification for signaling and requirements of the fire panel. In some scenarios, the voltage droop can be sufficiently large so as to cause an adverse response at the fire panel which may potentially lead to improper operation of the fire alert system. In that case, the fire panel can be modified (e.g. by a hardware or software modification) so that any adverse response at the fire panel may be prevented. For example, the fire panel can be modified so that a voltage droop during the transmit period does not trigger an adverse response or malfunction from the fire panel.

In other circuit configurations, the addition of the energy harvester 418 can vary or reduce the modulation index of the signal impressed upon the line pair by the transmitter 414. But the energy harvester 418 can be designed so that the change in modulation index is sufficiently small so as not to adversely affect communications and/or cause an adverse response from the fire panel. The amount of variation in the modulation index which can be accommodated or tolerated by each fire panel can depend on the system design specification with regard to signaling and the requirements of the fire panel. In some scenarios, the change in modulation index can be sufficiently large so as to cause an adverse response at the fire panel which may potentially lead to improper operation of the fire alert system. To prevent such improper operation, the fire panel can be modified (e.g. by a hardware or software modification) so that any adverse response at the fire panel may be prevented. For example, the fire panel can be modified so that a reduced modulation index during the transmit period does not trigger an adverse response or malfunction from the fire panel.

According to another embodiment, the particular detector device can be configured to perform energy harvesting during a brief guard period defined or coordinated by the interrogation signal from the fire panel. For example, the guard period may be defined as a brief period occurring immediately after a device is interrogated by a fire panel but before the transmit time of the detector device. Alternatively, the guard period could comprise a brief period after the transmit time of the detector device but before the interrogation or polling operation begins for the next detector device.

The foregoing concept is illustrated in FIG. 6 which shows a fire panel communicates an interrogation signal on a line pair. The interrogation signal is directed or addressed to a first detector device (Device 1) during an interrogation period 602, thereby causing the first detector device (e.g. detector device 406) to transmit a reply during a transmit period 604. Thereafter, the fire panel communicates an interrogation signal directed to a second detector device (Device 2) during a subsequent interrogation period 606, thereby causing the second detection device to transmit a reply during a transmit period 608. Device 1 can perform energy harvesting during transmit period 604 as described above. In addition Device 1 can perform energy harvesting during one or both guard periods 603, 605. Device 2 can perform energy harvesting during transmit period 608. In addition Device 2 can perform energy harvesting during one or both guard periods 607, 609. The process can continue for each of a plurality of n detector devices which are connected to an SLC.

According to a further aspect, the energy harvester can be integrated as part of the transmitter circuitry so that the modulation shown in FIGS. 2 and 3 is generated at least in part by performing energy harvesting operations. For example, the synchronization pulse 202 could be caused by a temporary energy harvesting electrical load which is connected across the line pair during a time period corresponding to the synchronization pulse. The temporary energy harvesting load could be selected to produce the required synchronization pulse. Similarly, the modulation introduced to the DC line voltage (e.g., modulation 204, 304) could be caused by a selective connection of a temporary energy harvesting electrical load across the line pair to produce the required modulation pattern. So instead of the power from the line pair being simply dissipated by the transmitter as part of the process of modulating the DC line voltage, the power will be utilized for energy harvesting purposes.

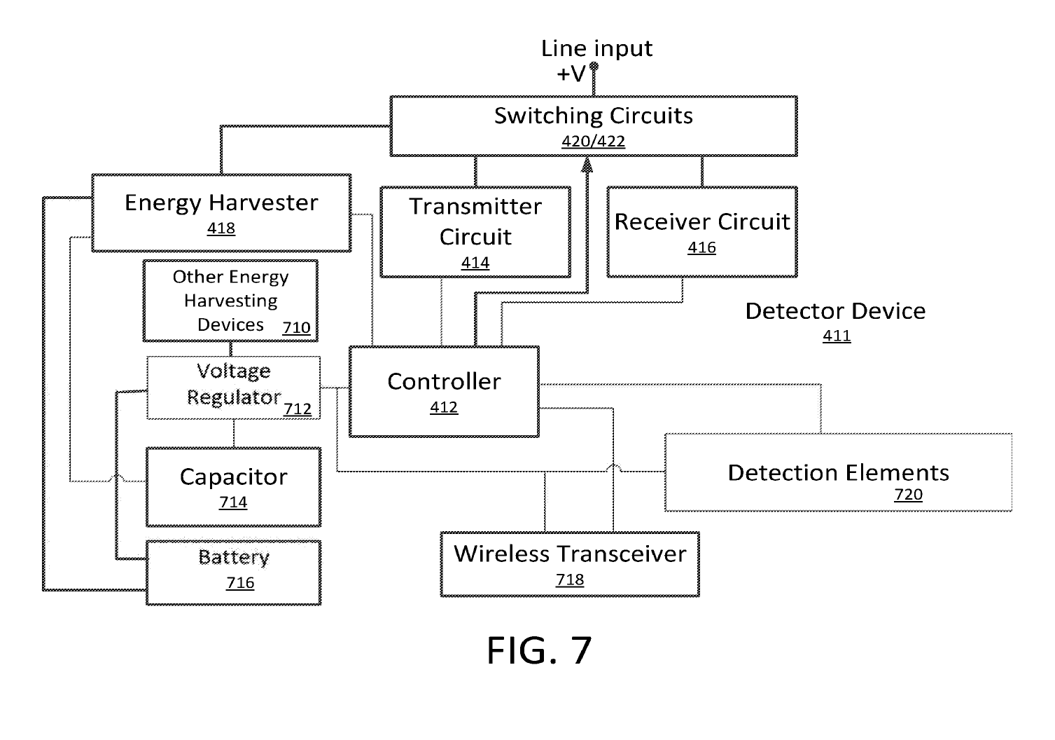

Referring now to FIG. 7, there is shown a more detailed block diagram of the electronic circuit 411. In addition to the various functional blocks already described, it can be observed in FIG. 7 that the electronic circuit 411 can include a voltage regulator circuit 712, a capacitor 714, a battery 716, a wireless transceiver 718 and a detection element 720. In some embodiments, the electronic circuit can also include other energy harvesting devices 710.

The voltage regulator 712 receives as an input the DC voltage supplied on the line pair (e.g. line pair 408) and provides a regulated voltage output which serves as primary power source for operating the electronic circuit 411. The function of the voltage regulator 712 is to provide a stable voltage output for powering the detector device, particularly during periods when signaling is in progress on the line pair. The function of the voltage regulator is facilitated by an energy storage element such as capacitor 714 which helps regulate the output of the voltage regulator during periods when the DC voltage is varying as a result of the signaling. In some scenarios, the energy storage capacity of the capacitor 714 may be large enough to sustain the operation of the detector and all of the enhanced sensor detection sensors and circuits at all times. If not, an optional battery 716 can be provided to store additional energy and thereby facilitate operation of the various enhanced detection sensors and circuits. The battery 716 can be trickle charged using the energy available as a result of energy harvester operations described herein. During periods between energy harvesting, the battery 716 and/or capacitor 714 can help support the operation of the voltage regulator by providing a stable DC voltage to the device.

The voltage regulator 712 can provide power to a basic fire detection sensor element. In addition, because of the additional power made available as a result of the energy harvesting operations, the voltage regulator can supply power needed to operate a plurality of enhanced fire detection sensor elements. For example, a basic fire detection sensor element could be a smoke or heat detector, and the plurality of enhanced fire detection sensor elements could be selected from the group consisting of carbon dioxide sensors, carbon monoxide sensors, volatile organic compound (VOC) sensors, light sensors, passive infrared sensors, and so on. Other optional sensing devices can include imaging devices such as video cameras and audio sensing circuits. All such possibilities of basic and enhanced sensors are represented by the detection element block 720 in FIG. 7. The choice of which sensors are considered basic and which are considered enhanced is not critical. The point is that the inclusion of additional sensing capability is made possible as a result of the additional power scavenged from the line voltage during energy harvesting operations as described herein.

Further, it should be appreciated that the additional power made available during energy harvesting operations can be used to power devices other than sensing devices. For example, the energy harvesting operations can facilitate powering of auxiliary communication devices, such as a wireless transceiver 718. The wireless transceiver can then provide auxiliary communications to a fire panel equipped with a wireless transceiver in the event the line pair supplying DC power to the circuit 411 has been disrupted or otherwise damaged.

A controller 412 for controlling the operations of the detector device can be any suitable logic circuit which is capable of facilitating the functions described herein. As such, the controller can be one or more devices such as a processor, an application specific circuit, a programmable logic device, a digital signal processor, or other circuit programmed to perform the functions described. A controller may be a digital controller, an analog controller or circuit, an integrated circuit (IC), a microcontroller, formed from discrete components, or the like. In some scenarios, the controller 412 can perform coding and/or decoding functions associated with receiving and transmitting operations as described.

The energy harvesting in a detector device described herein has thus far focused on energy which is derived from the line voltage supplied by the fire panel. However, it should be appreciated that this energy harvesting can be further supplemented by utilizing other energy harvesting devices 710 which are now known or may become known in the future. Exemplary energy harvesting components of this type can include devices which harvest energy utilizing ambient light, vibration, RF energy and so on. Devices for harvesting energy utilizing these alternative energy sources are known and therefore will not be described here in detail. However, it will be appreciated that energy harvested using such means can supplement the energy which is harvested from the line pair.

The invention has been described herein with respect to harvesting energy in a detector device, but it should be understood that the invention is not limited in this regard. In a fire alert system, other devices may be present on the same or other SLC loops. For example, annunciators, strobes, pull stations and other devices may be present on the same or different SLC loops. Addressable devices of this kind can also harvest available power using techniques similar to those described herein. The additional power which is harvested can be used for any purpose associated with enhancing the fire alert systems operations.

Further, it should be appreciated that the invention is not limited to performing energy harvesting operations at a particular device which has actually been addressed in accordance with an interrogation signal. Instead, the interrogation signal could be used to specify a different device which is to perform charging operations. For example, a controller associated with each detector device can be programmed with an offset value. In such scenarios, a particular detector device could perform energy harvesting operations when the address value of an interrogation signal from a fire panel plus the offset value is equal to an address value of the particular detector device. Further, there may be situations in which it is desirable for two or more of the detector devices to perform energy harvesting operations concurrently during a particular period of time.

In such embodiments, a single transmitted interrogation address could be used to trigger energy harvesting at multiple detector devices. For example, this could be accomplished by programming a controller at each detector device to perform energy harvesting when its own address is detected in an interrogation signal, and/or when the detected interrogation signal plus some offset value is equal to its own address. Of course, the number of detector devices which can be permitted to harvest energy in this way must be carefully controlled so as to avoid placing excessive electrical load on the line pair.

Finally, it may be noted that embodiments of the invention have been described in which the fire panel supplies a DC voltage to a line pair for powering a plurality of devices (e.g., detector devices) which are connected to an SLC. In such embodiments, the signaling is performed by modulating the DC voltage to communicate data. Still, it should be understood that embodiments of the invention are not limited to DC type systems. In some embodiments, the voltage supplied by the fire panel can comprise alternating current (AC) and such systems may use other wire line signaling techniques. In such scenarios, a similar energy harvesting arrangement could be used, but the energy harvester would be configured to harvest electrical energy from the AC voltage on the line pair instead of a DC voltage. And energy harvesting operations would be coordinated using the interrogation signal from the fire panel in a manner similar to that which has been described above.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

We claim:

1. A method for harvesting available electrical power in a fire alert system, comprising:
providing through a wire line pair primary electrical power from a fire panel central monitoring station to a plurality of remote devices;
performing bidirectional communications between the fire panel central monitoring station and the plurality of remote devices by selectively modulating a voltage of the primary electrical power on the wire line pair in accordance with a predetermined communication protocol;
initiating the bidirectional communications by using the fire panel central monitoring station to modulate the voltage on the wire line pair so as to communicate a first message to one of the plurality of remote devices;
responding to the first message with a second message by modulating the voltage on the line pair using one of the plurality of remote devices which has been indicated by a remote device address specified in the first message; and
selectively harvesting energy from the wire line pair at one or more of the remote devices in accordance with the remote device address specified in the first message.

2. The method according to claim 1, wherein the harvesting of energy is performed at the remote device having the address specified in the first message.

3. The method according to claim 1, wherein the harvesting of energy is performed at a time concurrent with modulating the voltage on the line pair to form the second message.

4. The method according to claim 3, wherein the harvesting of energy is performed at a time concurrent with modulating the voltage on the line pair by the fire panel central monitoring station so as to communicate a third message following the second message.

5. The method according to claim 1, wherein the harvesting of energy is performed during at least one guard period which is defined as occurring immediately before or after the second message.

6. The method according to claim 1, wherein the harvesting of energy is performed concurrent with modulating the voltage on the line pair to form the second message and during at least one guard period occurring immediately before or after the second message.

7. The method according to claim 1, wherein the harvesting of energy is performed during a period of time associated with a synchronization pulse of the second message.

8. The method according to claim 1, further comprising wherein the energy harvesting is selectively controlled to cause the modulation of the voltage on the line pair so as to form the second message.

9. The method according to claim 1, wherein the first message is an interrogation signal directed to one of the plurality of remote devices to elicit a fire detection status.

10. The method according to claim 1, wherein the energy harvesting reduces the voltage appearing on the wire line pair temporarily during the energy harvesting.

11. The method according to claim 1, wherein the energy harvesting reduces a modulation index of the signal associated with the second message relative a predetermined modulation index of a communication protocol.

12. The method according to claim 1, further comprising storing the energy which is derived from the energy harvesting in at least one energy storage element selected from the group consisting of a battery and a capacitor.

13. The method according to claim 12, wherein the remote device is a detector device having at least one detector element designed to indicate the presence of fire, and the energy which is stored as a result of the energy harvesting is used to power at least one additional element in each of the plurality of remote devices which would otherwise exceed the limits of available power provided to the wire line pair by the fire panel central monitoring station.

14. The method according to claim 13, further comprising selecting the at least one additional component from the group consisting of a smoke sensor, a heat sensor, a carbon dioxide sensor, a carbon monoxide sensor, a volatile organic compound (VOC) sensor, a light sensor, a passive infrared sensor, an imaging sensor and an audio sensor.

15. An electronic device for remote wire line connection to a fire panel central monitoring station in a fire alert system, comprising:
a voltage regulator configured to regulate a supply voltage used to power the electronic device, the voltage regulator configured to receive through a wire line pair primary electrical power;
a receiver circuit and a transmitter circuit configured to facilitate bidirectional communications between the electronic device and a remote fire panel central monitoring station of the fire alert system in accordance with a predetermined communication protocol which involves selectively modulating a voltage of the primary electrical power on the wire line pair;
at least one energy harvesting circuit configured to selectively harvest electrical power from the wire line pair at certain times; and
at least one control circuit configured to
determine an initiation of the bidirectional communications by the fire panel central monitoring station resulting from a modulation of the voltage on the wire line pair as detected by the receiver circuit and comprising a first message to the electronic device;
cause the transmitter circuit to respond to the first message with a second message by modulating the voltage on the line pair when a predetermined device address is specified in the first message; and
selectively cause the energy harvesting circuit to harvest energy from the wire line pair in accordance with the device address specified in the first message.

16. The electronic device according to claim 15, wherein the at least one control circuit is configured to cause the harvesting of energy when the address specified in the first message is the address of the electronic device.

17. The electronic device according to claim 15, wherein the at least one control circuit is configured to cause the harvesting of energy at a time concurrent with modulating the voltage on the line pair to form the second message.

18. The electronic device according to claim 15, wherein the at least one control device is configured to cause the harvesting of energy during at least one guard period which is defined as occurring immediately before or after the second message.

19. The electronic device according to claim 15, wherein the at least one control device is configured to cause the harvesting of energy concurrent with modulating the voltage on the line pair to form the second message and during at least one guard period occurring immediately before or after the second message.

20. The electronic device according to claim 15, wherein the at least one control device is configured to cause the harvesting of energy during a period of time associated with a synchronization pulse of the second message.

21. The electronic device according to claim 15, wherein the energy harvesting circuit is configured to at least partially cause the modulation of the voltage on the line pair so as to form the second message.

22. The electronic device according to claim 15, further comprising at least one energy storage element selected from the group consisting of a battery and a capacitor in which the energy derived by the energy harvesting circuit is temporarily stored for use in powering other parts of the electronic circuit.

23. The electronic device according to claim 22, wherein the electronic device is a detector device having at least one detector element designed to indicate the presence of fire, and the energy which is stored in the energy storage element is used to power at least one additional monitoring element.

24. The electronic device according to claim 23, wherein the at least one additional monitoring component is selected from the group consisting of a smoke sensor, a heat sensor, a carbon dioxide sensor, a carbon monoxide sensor, a volatile organic compound (VOC) sensor, a light sensor, a passive infrared sensor, an imaging sensor and an audio sensor.
